(19) United States
(12) Patent Application Publication
(10) Pub. No.: US 2016/0121598 A1
(43) Pub. Date: May 5, 2016

(54) MULTILAYER ROLLER

(71) Applicant: HEWLETT-PACKARD DEVELOPMENT COMPANY, L.P., Houston, TX (US)

(72) Inventors: Xiaoqi Zhou, San Diego, CA (US); Lokendra Pal, San Diego, CA (US); Xulong Fu, San Diego, CA (US)

(21) Appl. No.: 14/894,171

(22) PCT Filed: May 29, 2013
(86) PCT No.: PCT/US2013/043183

§ 371 Date: Nov. 25, 2015

(51) Int. Cl. B41F 3/54

(52) U.S. Cl. CPC B41F 3/54

(57) ABSTRACT

A multilayer roller includes a thermally insulating cylinder, a rigid outer cylinder and an annular elastomeric layer. The rigid outer cylinder is arranged coaxially with the thermally insulating cylinder and is an outermost layer of the multilayer roller. The rigid outer cylinder has a smooth surface. The annular elastomeric layer is disposed between the thermally insulating cylinder and the rigid outer cylinder.

### CROSS-REFERENCE TO RELATED APPLICATIONS

N/A

### STATEMENT REGARDING FEDERALLY SPONSORED RESEARCH OR DEVELOPMENT

N/A

### BACKGROUND

Printing, especially publishing and various forms of commercial printing, often requires a high quality, durable, and sometimes even a glossy finish to the printed article being printed. For example, coated print media such as so-called photo paper is often employed with various digital printing systems to produce relatively high quality results with good image quality and gloss when printing with a printer (e.g., inkjet printer, laser printer, etc.). Photo paper and similar coated media typically include paper that is coated with a specialized receiving layer to produce photographic-like results using digital printing.

However, there are disadvantages to using coated print media such as photo paper. For example, durability of a printed surface on coated print media may be limited, especially with high-speed digital printing, since ink particles may be confined at or near a surface of the coated print media after printing. Such surface-bound ink particles may be particularly susceptible to damage by rubbing or other surface abrasion, for example.

In addition to coated print media, a printed article having a glossy surface finish may be produced using a process known as ‘calendaring’ that employs a combination of various pressures and temperatures to effectively smooth a surface of the print media prior to printing. Unfortunately, while calendaring can yield a printed article with a relatively high gloss finish, the pressures and temperatures employed in calendaring may adversely affect one or both of ink adsorption and ink dry time.

Moreover, calendaring (e.g., especially before printing) may reduce an overall strength of the print media. Print media with adequate strength may be critical in various high speed printing applications including, but not limited, roll-to-roll digital printing, for example. As such, while image quality and surface finish are often important factors in printing, mechanical resistance to rubbing and other mechanical wear of the printed article along with durability and tear resistance of the printed article itself are also important considerations in many printing applications.

### BRIEF DESCRIPTION OF THE DRAWINGS

Various features of examples in accordance with the principles described herein may be more readily understood with reference to the following detailed description taken in conjunction with the accompanying drawings, where like reference numerals designate like structural elements, and in which:

FIG. 1A illustrates a cross sectional view of a multilayer roller, according to an example consistent with the principles described herein.

FIG. 1B illustrates a perspective view of the multilayer roller illustrated in FIG. 1A, according to an example consistent with the principles described herein.

FIG. 2A illustrates a cross sectional view of a multilayer roller, according to an example consistent with the principles described herein.

FIG. 2B illustrates an expanded cross sectional view of a portion of the multilayer roller illustrated in FIG. 2A, according to an example consistent with the principles described herein.

FIG. 3 illustrates a block diagram of a multilayer roller system, according to an example consistent with the principles described herein.

FIG. 4 illustrates a block diagram of a print media coating system, according to an example consistent with the principles described herein.

Certain examples have other features that are one of in addition to and in lieu of the features illustrated in the above-referenced figures. These and other features are detailed below with reference to the above-referenced figures.

### DETAILED DESCRIPTION

Examples in accordance with the principles described herein include a multilayer roller and multilayer roller system to provide a durable, glossy printed article. In particular, a post-printing treatment of the printed article using the multilayer roller provides a durable, glossy finish to a printed surface of the printed article, according to various examples. Using the multilayer roller including a combination of a smooth, rigid outer surface layer and a deformable elastomeric layer of the multilayer roller may provide a high gloss finish without resulting in ‘mottling’ or other non-uniform characteristics of a coating on the printed surface, for example. Further, as a post-printing process, using the multilayer roller generally does not interfere with ink reception and drying time of a printed image on the printed article. Moreover, providing the glossy surface finish with the multilayer roller according to the principles herein, may preserve or at least not adversely affect a strength of print media employed for the printed article, according to various examples. As such, thinner print media may be employed, in some examples.

Herein, ‘print media’ is defined as any media that is or may be printed upon, including but not limited to, paper stock, cardboard, paperboard, book stock, offset stock, linerboard, packaging board, corrugated board, or paper laminated with plastics, plastics, metals, cloth and fabrics. For example, print media may refer to cellulose paper. The cellulose paper may be either plain paper or coated paper comprising a base paper, a surface sizing layer, multiple coating layers and a treated surface (e.g., inkjet pre-coat treated surface). The base paper may have a weight ranging from about 35 gram per square meter (gsm) to about 500 gsm, for example. According to various examples, the base paper includes, but is not limited to, mechanical pulps (e.g., ground wood pulp, thermomechanical pulp and chemo-thermomechanical pulp), chemical pulps (Sulfate or Kraft, Sulfite), recycled pulp and combinations thereof. The surface sizing layer may comprise one or more of a starch, a multivalent metallic salt, an optical brightening agent (OBA), a synthetic sizing compound and a dye are selectively applied to the base paper surface, according to various examples. In some examples, the surface sizing is in an amount between about 0.001 to about 3 gsm per surface (e.g., one or both of a front and a back surface of the base paper). Surface treatment of coated paper may be provided by application of a mixture of pigment, multivalent metallic salt, polymer binder and a processing aid to a surface of a base paper, e.g., during paper manufacturing.

According to various examples, an inkjet pre-coat treated surface may be provided by one or more of offline, ‘nearline’ and inline priming in which one or more of high glass transition temperature polymers, a multivalent metallic salt, a water soluble or water dispersible latex binder, a slip aid, a large particle wax beads, a cross-linker, an optical brightening agent (OBA), a synthetic sizing compound and a dye are selectively applied to a surface of the print media, according to various examples. In some examples, the inkjet pre-coat is in an amount between about 0.001 to about 3 gsm per surface (e.g., one or both of a front and a back surface of the print media). The inkjet pre-coat surface layer may be applied by a variety of methods including, but not limited to, flexo, reverse flexo, forward flexo, gravure, offset, rod, blade, air knife, size press, curtain, and slot dye systems.

Herein, a ‘printed article’ is defined as a print medium that has been printed. In particular, a printed article is a print medium after passing through a printer or similar printing process to apply an ink (e.g., inkjet ink) or toner (either dry toner or liquid toner) to a surface of the print media. Further, the printed article may be printed on one or both sides or surfaces of the print medium, according to various examples. A printed article may also be referred to as a ‘printed’ medium to distinguish over a print medium prior to printing.

According to various examples, the printed article may be produced by applying ink to a surface of print media using any of a variety of printing methods and systems. For example, the ink may be applied using an inkjet printer or inkjet process. An inkjet web press or simply ‘web press’ herein refers to substantially any method or printing system in which several pens or ink delivery apparatuses of the same color are fixed in overlapping positions to facilitate printing on a substantially full width of passing print media (i.e., the ‘web’) that moves beneath the pens to receive droplets of ink. In some examples of a web press, several rows of pens with different colored inks (e.g., cyan, magenta, yellow and black) are fixed in positions to provide full color printing.

Further, as used herein, the article ‘a’ is intended to have its ordinary meaning in the patent arts, namely ‘one or more’. For example, ‘a layer’ means one or more layers and as such, ‘the layer’ means ‘the layer(s)’ herein. Also, any reference herein to ‘top’, ‘bottom’, ‘upper’, ‘lower’, ‘up’, ‘down’, ‘front’, back', ‘left’ or ‘right’ is not intended to be a limitation herein. Herein, the term ‘about’ when applied to a value generally means within the tolerance range of the equipment used to produce the value, or in some examples, means plus or minus 10%, or plus or minus 5%, or plus or minus 1%, unless otherwise expressly specified. Further, herein the term ‘substantially’ as used herein means a majority, or almost all, or all, or an amount with a range of about 51% to about 100%, for example. Moreover, examples herein are intended to be illustrative only and are presented for discussion purposes and not by way of limitation.

According to various examples of the principles described herein, a multilayer roller is provided. The multilayer roller is used to fuse or otherwise cure a printed surface of a print medium (i.e., printed article) using a combination of heat and pressure, in some examples. In some examples, the printed surface is uncoated. In other examples, the printed surface is coated (i.e., either pre-printing or post-printing) with a polymeric coating and the multilayer roller is used to fuse or otherwise cure the polymeric coating on the printed surface. Further, a combination of a substantially smooth surface of the multilayer roller and an off-axis movement or movability of an outer layer of the multilayer roller relative to an axis of rotation thereof facilitates providing the printed surface with a durable, glossy surface finish, according to various examples. Herein, a ‘polymeric coating’ is defined as a coating material comprising a polymeric compound (i.e., a polymeric compound-containing coating is a polymeric coating, by definition herein). In various examples, the polymeric coating may be used one or both as a pre-coat before printing and as an overcoat to coat a printed article after printing, by definition.

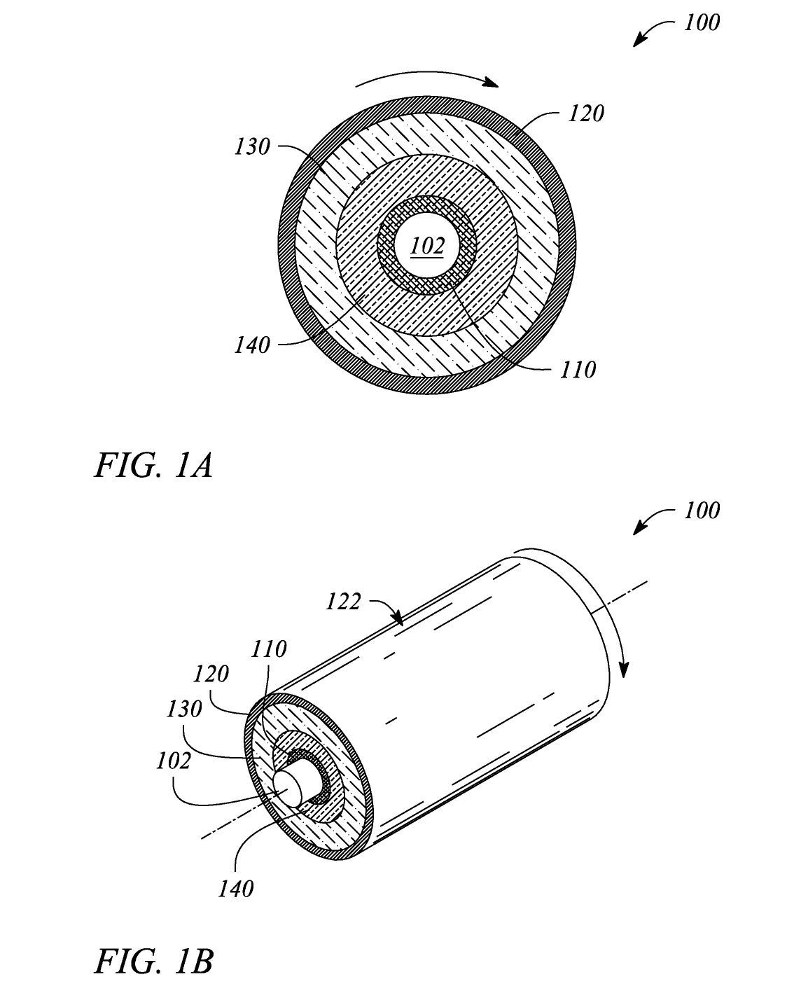

FIG. 1A illustrates a cross sectional view of a multilayer roller 100, according to an example consistent with the principles described herein. FIG. 1B illustrates a perspective view of the multilayer roller 100 illustrated in FIG. 1A, according to an example consistent with the principles described herein. The multilayer roller 100 may be configured to rotate about an axle 102 positioned along a central axis of the multilayer roller 100. In FIG. 1B, a dashed line illustrates the central axis of the multilayer roller 100 and a curved arrow illustrates rotation of the multilayer roller 100 about the central axis and the axle 102.

In some examples (not illustrated), the axle 102 may be connected to a drive system (e.g., a drive motor or drive gearing) to actively drive rotation of the multilayer roller 100 about the axle 102. In other examples (not illustrated), the axle 102 may be passively supported to facilitate rotation, while another means of driving the multilayer roller 100 is employed. For example, contact between the multilayer roller 100 and a moving print media or web (not illustrated) provides rotation of the multilayer roller 100 about the axle 102. In another example, a rotating backing roller (not illustrated) pressing against an outer surface of the multilayer roller 100 may provide the rotation.

The multilayer roller 100 comprises a thermally insulating cylinder 110. In some examples, the thermally insulating cylinder 110 is an inner most layer of the multilayer roller 100. In particular, the thermally insulating cylinder 110 may be located adjacent to and coaxially with the axle 102 about which the multilayer roller 100 is configured to rotate. In some examples (not illustrated), the thermally insulating cylinder may be coaxial with but not directly adjacent to the axle 102 (e.g., separated by another layer or cylinder of the multilayer roller 100). However, whether directly adjacent to or indirectly adjacent to the axle 102, the thermally insulating cylinder 110 is configured to provide thermal insulation between the multilayer roller 100 and the axle 102. In particular, the thermally insulating cylinder 110 is configured to substantially isolate the axle 102 from heat of the multilayer roller 100. The heat isolation may prevent, reduce or minimize, depending on the example, the axle 102 as well as machinery to which the axle is attached (e.g., a drive system) from heating due to heat from the multilayer roller 100. As such, the thermally insulating cylinder 110 is positioned between the axle 102 and a heat source of the multilayer roller 100, described further below.

According to some examples, the thermally insulator cylinder 110 has a thermal conductivity of less than about 0.3 watts per meter kelvin (W/m·K). In some examples, the thermal conductivity of the thermally insulator cylinder 110 is less than about 0.2 W/m·K. The thermal conductivity of the thermally insulating cylinder 110 may be in a range between about 0.1 W/m·K and about 0.3 W/m·K, for example. In other examples, the thermal conductivity may be less than about 0.1 W/m·K. In some examples, the thermal conductivity may be somewhat higher provided that the heat isolation is sufficient to adequately protect one or both of the axle 102 and any machinery attached to the axle 102 from the heat of the multilayer roller 100.

According to some examples, the thermally insulating cylinder 110 has an operational or ‘working’ temperature of at least 100 degrees Celsius (° C.). Herein, ‘working temperature’ is defined as a temperature at or a temperature range below which normal or specified operation is performed or provided. As such, by definition substantially no degradation in either mechanical performance or thermal performance is likely to occur at a temperature below the working temperature. For example, the thermally insulating cylinder 110 having a working temperature of at least 100° C. explicitly means that a rated or expected thermal conductivity as well as an expected mechanical performance of the thermally insulating cylinder 110 are compatible with temperatures up to at least 100° C. In some examples, the working temperature is greater than about 120° C., or greater than about 250° C. The working temperature of the thermally insulating cylinder 110 may have range between about 120° C. and about 250° C., for example.

According to some examples, the thermally insulating cylinder 110 is fabricated from a variety of insulating materials including, but not limited to, ethylene-chlorotrifluoroethylene copolymer, ethylene-tetrafluorethylene copolymer and fluorinated ethylene propylene copolymer. In other examples, the thermally insulating cylinder 110 comprises a polyamide or a carbon fiber reinforced polyamide. In yet other examples, another structural thermal insulating material such as, but limited to, glass or fiberglass (e.g., resin impregnated fiberglass) is employed in fabricating the thermally insulating cylinder 110.

The multilayer roller 100 illustrated in FIGS. 1A and 1B further comprises an outer cylinder 120. The outer cylinder 120 is arranged coaxially with the thermally insulating cylinder 110 and as an outermost layer of the multilayer roller 100. The outer cylinder 120 is rigid and has a surface 122 that is generally smooth and in some examples substantially smooth. By ‘rigid’ it is meant that the outer cylinder 120 does not deform to a substantial extent under normal operating conditions of the multilayer roller 100. In particular, the rigid outer cylinder 120 is configured to retain a substantially cylindrical shape when the multilayer roller 100 is subjected to an applied pressure of up to about 25 megapascals (MPa), by definition herein. The substantially smooth surface 122 may be akin to or referred to as having a ‘mirror’ or mirror-like finish. The mirror finish of the outer cylinder 120 may serve to impart a glossy finish to print media processed using the multilayer roller 100. As such, the outer cylinder 120 may also be referred to as a glossing cylinder 120 and the multilayer roller 100 may be referred to as a multilayer glossing roller 100, according to some examples.

In some examples, the substantially smooth surface 122 of the outer cylinder 120 may have a roughness average (Rₐ) generally less than about 0.4 micrometers (μm). Herein, ‘substantially smooth’ is defined as a surface with an Rₐ less than about 0.4 μm. In some examples, the Rₐ of the surface 122 is less than about 0.2 μm. In yet other examples, the surface 122 has an Rₐ in a range from about 0.025 μm to about 0.2 μm. For example, the Rₐ of the surface 122 may be less about 0.1 μm. One or more of lapping, polishing and superfinishing may be employed to provide the substantially smooth surface 122 of the outer cylinder 120, for example.

In some examples, the surface 122 of the outer cylinder 120 is hardened. Hardening may be used to protect the smooth or substantially smooth surface 122 from damage or wear during use of the multilayer roller 100. In particular, the surface 122 of the outer cylinder 120 may have a Rockwell scale C (RHC) hardness of at least 40. In some examples, the outer cylinder 120 has an RHC hardness of greater than about 45 (e.g., between about 48 and about 52). In some examples, the RHC hardness of at least the surface 122 of the outer cylinder 120 is greater than about 60, or even greater than about 70.

In some examples, the outer cylinder 120 comprises a steel such as, but not limited to, carbon steel. The outer cylinder 120 may be fabricated from carbon steel such as, but not limited to, one or both of A106 carbon steel and C1020 carbon steel. In some examples, the outer cylinder 120 comprises stainless steel. The outer cylinder 120 comprising stainless steel may have a final RHC hardness of between about 48 and about 52, for example.

According to various examples, a thickness of the outer cylinder 120 is chosen to provide sufficient strength to ensure that the outer cylinder 120 is rigid. Typically, one or more of the material of the outer cylinder 120, the expected operating conditions (e.g., pressure and temperature) thereof, and overall dimensions of the multilayer roller 100 determine a minimum thickness for the outer cylinder 120. In some examples, a thickness greater than about 5 millimeters (mm) is sufficient to ensure that the outer cylinder 120 is rigid. For example, the outer cylinder 120 comprising stainless steel may have a thickness of about 7-8 mm. In other examples, a thickness of about 8 mm to about 10 mm, or even a greater thickness is employed (e.g., when the material of the outer cylinder 120 is stainless steel).

According to some examples, the substantially smooth surface 122 of the outer cylinder 120 is provided by one of a metal-matrix surface coating or a ceramic surface coating on the surface 122 of the outer cylinder 120. For example, the surface 122 of the outer cylinder 120 comprising 420 stainless steel is coated with a ceramic surface coating or a metal-matrix surface coating to provide the substantially smooth surface 122. The surface coating may further enhance the hardness of the outer cylinder 120.

Ceramic surface coatings to provide the substantially smooth surface 122 to the outer cylinder 120 include, but are not limited to, chrome oxide and aluminum oxide. For example, chrome oxide may be thermally sprayed onto the surface 122 of the outer cylinder 120 resulting in an RHC of about 72 and ultimately providing a surface finish having an Rₐ of about 0.1 μm with advanced finishing techniques. Metal-matrix surface coatings to provide the substantially smooth surface 122 include, but are not limited to, tungsten carbide, chrome carbide as well as other thermally sprayed carbide coatings. Thermally sprayed carbide coatings such as tungsten carbide may provide a substantially smooth surface 122 having an Rₐ of about 0.025 μm and an RHC of about 70, for example. In some examples, the carbide-based coatings comprise minute solid carbide particles mixed with another metal such as, but not limited to, one or more of nickel, chrome and cobalt. During thermal spraying, the other metal liquefies to facilitate creating a continuous coating of the metal-matrix surface coating on the surface 122 of the outer cylinder 120. A metal-matrix coating comprising nickel chrome mixed with tungsten carbide may provide a mirror-like, substantially smooth surface 122 with an added advantage that the finish generally will not oxidize.

Referring again to FIGS. 1A and 1B, the multilayer roller 100 further comprises an annular elastomeric layer 130. The annular elastomeric layer 130 is disposed between the thermally insulating cylinder 110 and the outer cylinder 120, according to various examples. The annular elastomeric layer 130 is configured to support the outer cylinder 120 around the thermally insulating cylinder 110 and to provide a connection between the thermally insulating cylinder 110 and the outer cylinder 120. In some examples (not illustrated), the annular elastomeric layer 130 directly connects or couples the thermally insulating cylinder 110 and the outer cylinder 120. In other examples, another layer (e.g., a heater layer 140 described below) is disposed between the annular elastomeric layer 130 and either the thermally insulating cylinder 110 (e.g., as illustrated in FIGS. 1A-1B) or the outer cylinder 120.

The annular elastomeric layer 130 is deformable. In particular, the deformable, elastomeric layer 130 is configured to deform to facilitate off-axis movement of the outer cylinder 120 relative to the thermally insulating cylinder 110. Herein, ‘off-axis movement’ is defined a movement of a first cylinder (e.g., the outer cylinder 120) relative to another cylinder (e.g., the thermally insulating cylinder 110) such that a central axis of the first cylinder is displaced relative to a central axis of the second cylinder. The displacement of the off-axis movement is generally along a radius of one of the cylinders, according to various examples. In some examples, the off-axis movement is provided by a pressure applied to the multilayer roller 100 perpendicular to the surface 122 of the outer cylinder 120, e.g., a pressure applied by a backing roller, described below.

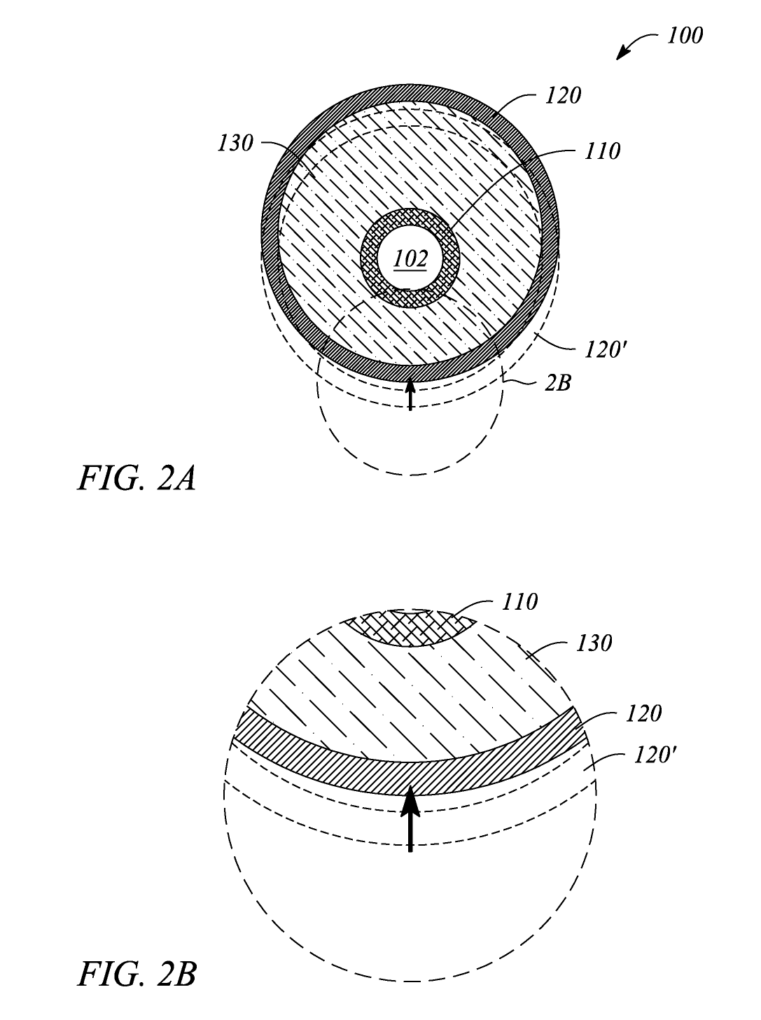

FIG. 2A illustrates a cross sectional view of a multilayer roller 100, according to an example consistent with the principles described herein. FIG. 2B illustrates an expanded cross sectional view of a portion of the multilayer roller 100 illustrated in FIG. 2A, according to an example consistent with the principles described herein. In particular, FIGS. 2A and 2B illustrate off-axis movement of the outer cylinder 120 relative to the thermally insulating cylinder 110 in a direction along a radius of the thermally insulating cylinder 110 as indicated by a heavy arrow. A double-dashed outline illustrates a location of the outer cylinder 120′ prior to off-axis movement. Deformation of the annular elastomeric layer 130 facilitates the off-axis movement. In particular, the annular elastomeric layer 130 is compressed where the outer cylinder 120 moves closer to the thermally insulating cylinder 110 due to the off-axis movement, while the annular elastomeric layer 130 is stretched or expanded on a side opposite the compression, as illustrated in FIG. 2A.

In some examples, the annular elastomeric layer 130 has a thickness that is greater than about 15 mm. In some examples, the thickness is greater than about 20 mm. The thickness of the annular elastomeric layer may be between about 20 mm and about 30 mm. In some examples, the thickness of the annular elastomeric layer 130 is greater than about 15 mm, or greater than about 20 mm. For example, the thickness of the annular elastomeric layer 130 is between about 15 mm and about 50 mm. In some examples, a minimum thickness ratio of the thickness of the annular elastomeric layer 130 to a thickness of the outer cylinder 120 may be greater than 3 to 1. The thickness ratio of the annular elastomeric layer 130 thickness to the outer cylinder 120 thickness may be greater than 20 to 1, for example. According to various examples, the annular elastomeric layer 130 may be molded or cast to provide the desired thickness. A thickness of the annular elastomeric layer 130 may be determined by a mechanical strength of the elastomeric layer sufficient to support the outer cylinder 120 and to provide mechanical integrity to the multilayer roller 100, for example.

As mentioned above, the annular elastomeric layer 130 is configured to deform (e.g., under pressure) while also providing mechanical integrity to the multilayer roller 100. Deformation may be controlled by a predetermined hardness of the annular elastomeric layer 130. In some examples, the annular elastomeric layer 130 has a hardness measured in terms of a Shore D durometer (i.e., Shore D, ASTM D 2240) of greater than about 10. In some examples, the Shore D durometer of the annular elastomeric layer 130 is greater than about 50. The Shore D durometer of the annular elastomeric layer 130 may have a Shore D durometer between about 10 and about 90, or between about 40 to about 60, for example.

In some examples, the annular elastomeric layer 130 comprises a plurality of layers. Each layer in the plurality may have a different hardness. An outermost layer of the plurality of layers of the annular elastomeric layer 130 may be generally softer than an inner layer of the plurality (e.g., a layer closer to the thermally insulating layer 110). A difference in hardness between the layers of the plurality may range from about 1.1 times to about 2.5 times. An inner layer of the plurality may have a Shore D durometer of about 20 while an outer layer may have a Shore D durometer of about 50. In some examples, an average Shore D durometer of the plurality of layers is between about 10 and about 90. In some examples, a minimum Shore D durometer of any of the layers of the plurality is about 10.

In some examples, the annular elastomeric layer 130 comprises a vulcanized elastomer. The vulcanized elastomers used in the annular elastomeric layer 130 may include, but are not limited to, a copolymer of butadiene and acrylonitrile; a copolymer of styrene and butadiene, a copolymer of isobutylene and isoprene, various halogenated butyl rubbers, chloroprene rubber, or polychloroprene rubber (e.g., neoprene or a Baypren® product from Bayer Material Science, PA). In other examples, the annular elastomeric layer 130 may comprise a non-vulcanized elastomer or a combination of vulcanized and non-vulcanized elastomers (e.g., in different layers). Examples of non-vulcanized elastomers that may be used in the annular elastomeric layer 130 include, but are not limited to, polybutadiene, ethylene propylene diene rubber, epichlorohydrin rubber, various fluoroelastomers and perfluoroelastomers, various ethylene-vinyl acetate copolymers, chlorosulfonated polyethylene or polysulfide. The various fluoroelastomers include, but are not limited to, copolymers of vinylidene fluoride, hexafluoropropylene, vinylidene fluoride, hexafluoropropylene or tetrafluoroethylene.

According to some examples, an elastomeric material of the annular elastomeric layer 130 is filled with a thermally conductive filler to increase a thermal conductivity of the annular elastomeric layer 130. The thermally conductive filler also may augment a mechanical strength of the annular elastomeric layer 130. In some examples, the thermally conductive filler comprises filler particles or powders dispersed in a matrix of elastomer (e.g., the vulcanized elastomer) of the annular elastomeric layer 130. Examples of thermally conductive fillers include, but are not limited to, boron nitride (BN), aluminum nitride (AlN), or silver nitride (Ag₃N), or various metals, such as silver (Ag), copper (Cu), aluminum (Al), or various alloys thereof. In some examples, the thermally conductive filler comprises one or more of silver coated copper, silver coated aluminum and carbon fibers or powder (e.g., carbon black). In other examples, various oxides such as, but not limited to, zinc oxide (ZnO), titanium oxide (TiO₂), aluminum oxide (Al₂O₃) or silicon oxide (SiO₂), may be used as or in the thermally conductive filler. Certain carbonates including, but not limited to, calcium carbonate (CaCO₃), magnesium carbonate (MgCO₃) or aluminum carbonate (Al₂(CO₃)₃) may also be useful as the thermally conductive filler.

In some examples, the thermal conductivity of the annular elastomeric layer 130 is related to a volume friction by a percent of an amount of the elastomer relative to an amount of the thermally conductive filler. The percent may be between about 5% and about 40% by weight, for example. According to some examples, a thermal conductivity of the annular elastomeric layer 130 is greater than about 0.2 W/m·K. For example, the thermal conductivity is between about 0.3 W/m·K and about 0.7 W/m·K.

According to various examples, the annular elastomeric layer 130 has a working temperature of at least about 40° C. In other examples, the working temperature of the annular elastomeric layer 130 is at least about 100° C. In yet other examples, the working temperature is greater than about 150° C., or greater than about 200° C. The working temperature may have a range from about 100° C. to about 250° C. The working temperature range of the annular elastomeric layer 130 may be chosen to facilitate heating a surface of the multilayer roller 100 to between about 40° C. and about 250° C.

According to various examples, the multilayer roller 100 is heatable (e.g., is a heated roller). The multilayer roller 100 may be heatable by an external heater. The external heater may be an infrared, quartz or halogen heat source positioned to illuminate the multilayer roller 100, for example. In another example, the heater is integral to the multilayer roller 100. The integral heater may be implemented as a layer of the multilayer roller 100, for example.

In particular, referring again to FIG. 1A, the multilayer roller 100 may further comprise a heater layer 140 disposed between the thermally insulating cylinder 110 and the outer cylinder 120. The heater layer 140 is located between the thermally insulating cylinder 110 and the annular elastomeric layer 130 in FIGS. 1A-1B. In other examples (not illustrated), the heater layer 140 is disposed between the annular elastomeric layer 130 and the outer cylinder 120. In yet other examples (not illustrated), the heater layer 140 may be disposed within the annular elastomeric layer 130 (e.g., between adjacent layers of a plurality of layers of the annular elastomeric layer 130). In some examples, both the heater layer 140 and an external heater are configured to heat and maintain an elevated temperature of the multilayer roller 100.

According to various examples, one or both the heater layer 140 and an external heater (not illustrated) are configured to provide sufficient heat to maintain a predetermined target surface temperature of the multilayer roller 100. In some examples, the heater layer 140 is configured to heat a surface of the multilayer roller 100 (e.g., the surface of the outer cylinder 120) to a surface temperature of greater than about 40° C. The heater layer 140 may provide sufficient heat to maintain the surface 122 of the outer cylinder 120 between about 40° C. and about 250° C.

In some examples, the heater layer 140 comprises a metal or a similarly thermally conductive cylindrical shell that houses a heating element. For example, the heater layer 140 may comprise a conductive metal such as, but not limited to, steel, aluminum, copper or various alloys that provide high thermal conductivity. The heating element may comprise a quartz heat lamp, a resistance heater such as, but not limited to, a Nichrome wire, ribbon or strip, or another means for providing heat. The heater layer 140 may be substantially any heater, for example those employed to heat fusing rollers used in laser printers.

According to various examples of the principles described herein, a multilayer roller system is also provided. The multilayer roller system may be employed to provide an overcoat to a printed surface of a printed article, for example. In other examples, the multilayer roller system may be employed with a printed article that includes a coating applied prior to printing. In yet other examples, the multilayer roller system may be employed in conjunction with a printed article without a coating (i.e., an uncoated printed article). The printed article may comprise a print medium with printing on a surface (i.e., the printed surface) of the print medium, according to various examples. The coating (e.g., pre-printing coating or post-printing overcoat) may one or both produce a glossy finish on the printed article and serve as a protective layer over the printed surface to enhance durability, for example.

In some examples, the glossy, durable finish enhances image quality of the printed surface without substantially impacting an overall strength of the printed article or an underlying print medium thereof. In some examples, the multilayer roller system is integrated in-line in a printer system such as, but not limited to, a high-speed inkjet web press. In other examples, the multilayer roller system is a stand-alone post-printing processing system configured to receive a printed article and provide a glossy coating to the printed article. In yet other examples, the multilayer roller system provides both pre-printing processing (i.e., coating application) and post-printing processing (i.e., rolling) of the printed article.

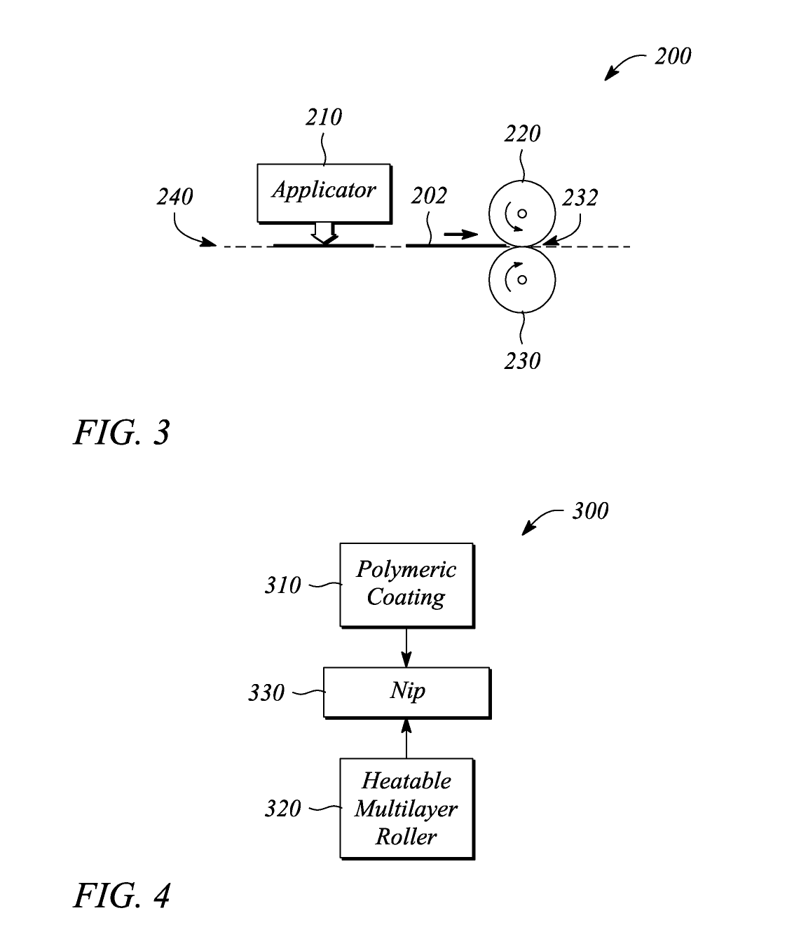

FIG. 3 illustrates a block diagram of a multilayer roller system 200, according to an example consistent with the principles described herein. The multilayer roller system 200 may be configured as portion of a printing system, according to some examples. In particular, the multilayer roller system 200 may be located in the printing system to receive a printed article 202 at an output of a printing portion of the printing system but before a printed article collection portion (e.g., a web press take-up roller or an output tray/collator), according to some examples.

In some examples (e.g., as illustrated in FIG. 3), the multilayer roller system 200 comprises an applicator 210. The applicator 210 is configured to apply a polymeric coating material either on the printed article 202 or on a print medium prior to printing. In particular, according to some examples, the polymeric coating is applied to after printing as a polymeric ‘overcoat’ on the printed article 202 produced from the print medium. In these examples, the applicator 210 may be located after a printer that produces the printed article 202. In other examples, the polymeric coating is applied prior to printing as a pre-coat. In these examples (not illustrated), the applicator 210 may be located before the printer.

According to various examples, the polymeric coating material may comprise a liquid suspension of polymeric particles. Application and coating of the polymeric coating by the applicator 210 are configured to provide a uniform coating covering either the printed surface of the printed article 202 or a printable surface of the print medium, according to various examples. The applicator 210 may comprise one or more of a spray coater, a roller coater (e.g., an anilox coater), and a thermal jet to apply and coat the polymeric coating material onto the printed article 202. In other examples, the applicator 210 applies the polymeric coating material using one or more of rod coating, dip coating, film transfer and curtain coating, air spreading, air knife, and various types of gravure coating.

As illustrated, the multilayer roller system 200 further comprises a heatable multilayer roller 220. In some examples, the heatable multilayer roller 220 may be substantially similar to the multilayer roller 100, described above. In particular, the heatable multilayer roller 220 may comprise a thermally insulating cylinder, a rigid outer cylinder having a substantially smooth outer surface, and a deformable elastomeric layer sandwiched between the thermally insulating cylinder and the rigid outer cylinder. Each of the thermally insulating cylinder, the rigid outer cylinder and the deformable elastomeric layer of the heatable multilayer roller 220 may be substantially similar to respective ones of the thermally insulating cylinder 110, the outer cylinder 120 and the annular elastomeric layer 130, described above with respect to the multilayer roller 100. In some examples, the heatable multilayer roller 220 with the substantially smooth outer surface is or may be referred to as a heatable glossing roller 220.

In some examples, the heatable multilayer roller 220 further comprises an integral heater to heat the substantially smooth outer surface of the rigid outer cylinder. The integral heater may be a heater layer that is substantially similar to the heater layer 140 described above with respect to the multilayer roller 100. In particular, the integral heater may be configured to heat the rigid outer cylinder surface to greater than about 40° C., or greater than about 100° C., or for example, to a temperature described above for the multilayer roller 100. In other examples, an external heater (e.g., an infrared heater) is used to heat the heatable multilayer roller 220. The heat provided by the heater, whether the integral heater or an external heater, is predetermined to be sufficient to fuse the polymer particles of the polymeric coating on the printed article 202. Further, due to the printed article passing by the heatable multilayer roller 220, the heat is applied to the printed article 202 to fuse the polymer particles for only relatively short time (i.e., while the printed article is in contact with the heatable multilayer roller 220), according to various examples.

The multilayer roller system 200, illustrated in FIG. 3, further comprises a backing member 230. The backing member 230 is disposed adjacent to the heatable multilayer roller 220 to provide a nip 232 between the heatable multilayer roller 220 and the backing member 230. According to some examples, deformation of the deformable elastomeric layer in the heatable multilayer roller 220 is produced by pressure between the heatable multilayer roller 220 and the backing member 230 at the nip 232. The deformation is configured to provide off-axis motion of the rigid outer cylinder relative to the thermally insulating cylinder of the heatable multilayer roller 220. According to various examples, the pressure along with heat provided by the heatable multilayer roller 200 is configured to one or both of cure and provide a gloss to the polymeric coating. The pressure may be in a range from about 0.3 MPa to about 25 MPa, or between about 2 MPa and about 15 MPa, for example. In some examples, the nip 232 is a glossing nip 232 (e.g., when the heatable multilayer roller 220 is a heatable glossing roller 220).

In some examples (e.g., as illustrated in FIG. 3), the backing member 230 comprises a backing or backside pressure roller 230. The backside pressure roller 230 may be a deformable roller or a conformable roller. For example, the backside pressure roller 230 may comprise an elastomeric material selected from the elastomer materials provided above for the annular elastomeric layer 130. In some examples, the elastomeric material of the backside pressure roller 230 is filled with a thermally conductive filler, such as described above for the annular elastomeric layer 130. However in other examples, the elastomeric material of the backside pressure roller 230 is not so filled. In another example, the backside pressure roller 230 comprises a hard material such as, but not limited to, steel. A surface of the backside pressure roller 230 may be polished or otherwise configured to provide a substantially smooth surface, according to some examples.

In yet other examples, the backing member 230 comprises another heatable multilayer roller having a rigid, smooth, outer cylinder coaxially disposed about a thermally insulating cylinder with an elastomeric layer sandwiched between the rigid smooth outer cylinder and the thermally insulating cylinder, e.g., also substantially similar to the multilayer roller 100. In some examples, the applicator 210 is configured to further provide application of the polymeric coating to a second surface of either the print medium (pre-printing) or the printed article (post printing) and the other heatable multilayer roller of the backing member 230 is configured to cure and gloss the polymeric coating on the second surface. In some examples, the other heatable multilayer roller of the backing member 230 is a heatable glossing roller configured to provide a glossy finish to the polymeric coating on the second surface. In still other examples, the backing member 230 comprises a substantially smooth belt or a shoe to provide the nip 232.

The multilayer roller system 200 further comprises a print media path 240 between the heatable multilayer roller 220 and the backing member 230. The print media path 240 is configured to carry the printed article 202 through the nip 232. As the printed article 202 moves along the print media path 240 through the nip 232, the heatable multilayer roller 220 facilitated by the backing member 230 may fuse or otherwise cure a polymeric coating on the printed article, in some examples. In other examples, the printed article carried along the print media path 240 through the nip 232 is uncoated. Contact between the substantially smooth surface of the heatable multilayer roller 220 and the printed article 202 (i.e., coated or uncoated) imparts a glossy, durable finish at the nip 232 along the print media path 240, according to some examples.

According to various examples of the principles described herein, a print media coating system is provided. The print media coating system is configured to provide one or both of a durable and glossy finish to a printed article either as an inline or an offline post-printing processing operation. FIG. 4 illustrates a block diagram of a print media coating system 300, according to an example consistent with the principles described herein.

The print media coating system 300 illustrated in FIG. 4 comprises a polymeric coating 310 configured to be applied a print medium. According to some examples, the polymeric coating 310 is applied to the print medium before printing, while in other examples, the polymeric coating 310 is applied after printing (i.e., applied to a printed article post-printing). According to some examples, the polymeric coating 310 comprises polymeric particles having a size between about 10 nanometers (nm) and about 1,000 nm. The size of the polymeric particles may be between about 100 nm and about 300 nm (e.g., average diameter). In some examples, the polymeric particles comprise a polymer having an average molecular weight greater than about 10,000. For example, the polymer of the polymeric particles may have a weight average molecular weight from about 10,000 to about 2,000,000. In another example, the weight average molecular weight may be between about 40,000 and about 100,000. Polymeric particles of the polymeric coating may comprise randomly polymerized monomers. Moreover, some of the polymeric particles may be cross linked together, and when cross-linked, combined molecular weights of the cross-linked polymeric particles may exceed a weight average molecular weight of about 2,000,000, for example.

According to some examples, the polymeric coating 310 comprises latex particles formed from combinations of various monomers. Example monomers that may be used to form the latex particles include, but are not limited to, styrenes, C1 to C8 alkyl methacrylates, C1 to C8 alkyl acrylates, ethylene glycol methacrylates and dimethacrylates, methacrylic acids, acrylic acids, combinations of two or more thereof, or mixtures of two or more thereof. The polymeric particles may include those prepared using an emulsion monomer mix of various weight ratios of styrene, hexyl methacrylate, ethylene glycol dimethacrylate, and methacrylic acid, which are copolymerized to form the latex. Styrene and hexyl methacrylate monomers may provide the bulk of the polymeric particulate and ethylene glycol dimethacrylate and methyl methacrylate may be copolymerized therewith in smaller amounts. In such examples, an acid group is provided by methacrylic acid.

According to various examples, the polymeric coating 310 further comprises a liquid carrier. The polymeric particles may be suspended in the liquid carrier in an amount between about 0.5 weight percent (wt %) and about 15 wt % prior to application. In some examples, the polymeric coating 310 is substantially similar to the polymeric coating material applied by the applicator 210 of the multilayer roller system 200 and the polymeric coating 310 may be applied using the applicator 210, for example. According to various examples, the polymeric particles of the polymeric coating have a film-forming or glass transition temperature from about 20° C. to about 100° C. to facilitate curing (i.e., fusing) with applied heat and pressure at the nip 330.

The print media coating system 300 further comprises a heatable multilayer roller 320 and a nip 330. A combination of the heatable multilayer roller 320 and the nip 330 is configured to convert the polymeric coating 310 on the print medium into a durable and glossy coating (e.g., one or both of a glossy pre-printing coating and a glossy overcoat after printing). According to some examples, the heatable multilayer roller 320 is substantially similar to the above-described multilayer roller 100. In particular, the heatable multilayer roller 320 may comprise a thermally insulating cylinder, a rigid outer cylinder having a substantially smooth outer surface, and an annular elastomeric layer sandwiched between the thermally insulating cylinder and the rigid outer cylinder. Respective ones of the thermally insulating cylinder, the rigid outer cylinder, and the annular elastomeric layer may be substantially similar to thermally insulating cylinder 110, the outer cylinder 120, and the annular elastomeric layer 130, according to some examples.

The nip 330 is located between the heatable multilayer roller 320 and a backing member (not illustrated). The backing member is configured to support the print medium with the applied polymeric coating, according to various examples. In some examples, the nip 330 is substantially similar to the nip 232 between the heatable multilayer roller 220 and the backing member 230, described above with respect to the multilayer roller system 200. Moreover, the backing member associated with the nip 330 may be substantially similar to the backing member 230 described above. In particular, the backing member may be a backside pressure roller aligned with the heatable multilayer roller 320 to provide pressure to a coated printed article at the nip 330. In some examples, the backside pressure roller is another heatable multilayer roller (e.g., substantially similar to the heatable multilayer roller 320).

In some examples, the print media coating system 300 further comprises a heater configured to heat the heatable multilayer roller 320. In some examples, the heater is an integral heater layer within the heatable multilayer roller 320. The integral heater may be substantially similar to the heater layer 140 described above with respect to the multilayer roller 100. In particular, the integral heater layer may be disposed between the thermally insulating cylinder and the rigid outer cylinder. Further, the integral heater layer may be located adjacent to the thermally insulating cylinder and the annular elastomeric layer, wherein the annular elastomeric layer may comprise a vulcanized elastomer filled with a thermally conductive filler. In other examples, the heater may be an external, non-contact heater configured to directly heat the substantially smooth outer surface of the rigid outer cylinder of the heatable multilayer roller 320. In some examples, the heater comprises both the integral heater layer and the external heater configured to operate together or separately to heat the heatable multilayer roller 320.

Thus, there have been described examples of a multilayer roller, a multilayer roller system and a print media coating system that include a multilayer roller including a rigid outer cylinder, an insulating cylinder and a deformable elastomeric layer sandwiched therebetween. It should be understood that the above-described examples are merely illustrative of some of the many specific examples that represent the principles described herein. Clearly, those skilled in the art can readily devise numerous other arrangements without departing from the scope as defined by the following claims.

What is claimed is:

1. A multilayer roller comprising:
a thermally insulating cylinder;
a rigid outer cylinder arranged coaxially with the thermally insulating cylinder, the rigid outer cylinder being an outermost layer of the multilayer roller and having a smooth surface; and
an annular elastomeric layer disposed between the thermally insulating cylinder and the rigid outer cylinder.

2. The multilayer roller of claim 1, wherein the thermally insulating cylinder has a thermal conductivity of less than about 0.3 watts per meter kelvin (W/m·K) and a working temperature of greater than about 100 degrees Celsius.

3. The multilayer roller of claim 1, wherein the smooth surface of the rigid outer cylinder has a roughness average (Rₐ) of less than about 0.4 micrometer.

4. The multilayer roller of claim 3, wherein the smooth surface of the rigid outer cylinder is provided by a metal-matrix surface coating comprising tungsten carbide and nickel chrome.

5. The multilayer roller of claim 1, wherein the rigid outer cylinder comprises stainless steel having a hardness of greater than about 45 on a Rockwell hardness scale C.

6. The multilayer roller of claim 1, wherein the rigid outer cylinder has a thickness greater than about 5 millimeters, and wherein the annular elastomeric layer has a Shore D durometer of greater than about 60.

7. The multilayer roller of claim 1, wherein the annular elastomeric layer comprises a vulcanized elastomer filled with a thermally conductive filler and has a thickness of greater than about 15 millimeters.

8. The multilayer roller of claim 1, further comprising a heater layer disposed between the thermally insulating cylinder and the rigid outer cylinder, the heater layer to heat the multilayer roller to a surface temperature of greater than about 40 degrees Celsius.

9. A multilayer roller system comprising:
a heatable multilayer roller comprising a thermally insulating cylinder, a rigid outer cylinder coaxial with the thermally insulating cylinder and having a smooth outer surface, and a deformable elastomeric layer sandwiched annularly between the thermally insulating cylinder and the rigid outer cylinder;
a backing member disposed adjacent to the heatable multilayer roller to provide a nip; and
a print media path between the heatable multilayer roller and the backing member at the nip,
wherein the smooth outer surface of the rigid outer cylinder has a surface roughness of less than about 0.4 micrometers.

10. The multilayer roller system of claim 9, further comprising an applicator to apply a polymeric coating material on a print medium, the applicator to apply the polymeric coating material one or both of as a pre-coat on the print media prior to printing and as post-printing overcoat on a printed article after printing.

11. The multilayer roller system of claim 9, wherein the heatable multilayer roller further comprises an integral heater to heat the smooth outer surface of the rigid outer cylinder to greater than about 40 degrees Celsius.

12. The multilayer roller system of claim 9, wherein the backing member comprise a backside pressure roller.

13. The multilayer roller system of claim 12, wherein the backside pressure roller comprises another heatable multilayer roller comprising a rigid outer cylinder with a smooth outer surface coaxially disposed about a thermally insulating cylinder with an elastomeric layer sandwiched between the rigid outer cylinder and the thermally insulating cylinder.

14. A print media coating system comprising:
a polymeric coating to be applied to a print medium, the polymeric coating comprising polymeric particles having a particle size between about 10 nanometers and about 1,000 nanometers and having an average molecular weight greater than about 10,000;
a heatable multilayer roller comprising a thermally insulating cylinder, a rigid outer cylinder coaxial with the thermally insulating cylinder and having a smooth outer surface, and an annular elastomeric layer sandwiched between the thermally insulating cylinder and the rigid outer cylinder; and
a nip between the heatable multilayer roller and a backing member to support the print medium with the applied polymeric coating.

15. The print media coating system of claim 14, further comprising a heater to heat the heatable multilayer roller, the heater being one or both of an integral heater layer within the heatable multilayer roller and an external, non-contact heater to heat the smooth outer surface of the rigid outer cylinder, wherein the integral heater layer is disposed between the thermally insulating cylinder and the rigid outer cylinder, the annular elastomeric layer comprising a vulcanized elastomer filled with a thermally conductive filler.
